(19) United States
(12) Patent Application Publication
(10) Pub. No.: US 2012/0176337 A1
(43) Pub. Date: Jul. 12, 2012

(54) Electronic Art System and Related Method

(75) Inventors: Lanny Starkes Smoot, Thousand Oaks, CA (US); Katherine M. Bassett, Lexington, MA (US)

(73) Assignee: DISNEY ENTERPRISES, INC., Burbank, CA (US)

(21) Appl. No.: 13/300,418

(22) Filed: Nov. 18, 2011

Related U.S. Application Data
(60) Provisional application No. 61/460,990, filed on Jan. 10, 2011.

(51) Int. Cl. G06F 3/042; G06F 3/044; G06F 3/041

(52) U.S. Cl. 345/174; 345/173; 345/175

(57) ABSTRACT

There is presented a system and method for producing art electronically. In one embodiment, an electronic art system comprises an electrically sensitive art surface, an art brush having bristles, a voltage reference coupled to the bristles of the art brush, and an at least lightly conductive liquid for moistening the bristles. An electrical pattern formed by an interaction between a plurality of the moistened bristles of the art brush executing a brushstroke and the electrically sensitive art surface, resulting in production of an image of the brushstroke. In other embodiments, the electronic art system can comprise one or more of a camera configured to capture an optical image of the brushstroke, a conductive micro-screen providing a residual image of the brushstroke, a position detection unit for identifying the location of the brushstroke on the electrically sensitive art surface, and a computer to process and produce the image of the brushstroke.

### RELATED APPLICATIONS

The present application claims the benefit of and priority to the pending provisional application entitled “Electronic Art System and Related Method,” Ser. No. 61/460,990, filed on Jan. 10, 2011, which is hereby incorporated fully by reference into the present application.

### BACKGROUND OF THE INVENTION

1. Field of the Invention

The present invention relates generally to the production of art imagery. More particularly, the present invention relates to producing art imagery electronically.

2. Background Art

Artists and animators are often highly skilled in the subtle command of an art brush or similar traditional art rendering tool to produce nuanced artistic images using paint or ink on canvas, for example. As computer art and graphics come to play an increasingly important role in our culture, however, there are ever more situations in which producing artwork or illustrations electronically may be considered advantageous or desirable for any of a variety of reasons, such as, for instance, ease of replication, and/or ease of distribution.

Unfortunately, conventional approaches to enabling the production of art images electronically suffer from significant limitations that may inhibit realization of the artist or animator's full complement of skills. Consequently, much of conventionally produced electronic artwork may seem primitive, or at least to lack sophistication, when compared with artwork produced using traditional non-electronic tools and media. For example, an often implemented approach to producing illustrations electronically involves the use of a stylus and an electronic slate. The artist or illustrator draws electronically by moving the stylus tip along the surface of the slate. Although this technique can be used successfully to produce both color and monochromatic images, the visual complexity of those images is fairly low due to their being produced substantially exclusively from the lines and curves impressed onto the slate surface by the stylus point. Absent from images produced in this conventional way are the fine grained “textured” effects produced by skillful application and control of the bristles of a traditional art brush.

One alternative conventional technique that attempts to electronically simulate the granularity of images produced using a traditional art brush, uses a drawing tool equipped with light emitting fibers in place of traditional art brush bristles. Such an approach typically measures the light impinging on a portion of a drawing surface and uses that measure relative to the total light emitted by the “brush” to estimate the number of fibers in contact with the surface. However, because the light emitted by these fibers typically emerges from the fiber ends, this method fails to capture several important brush techniques used by artists to add nuance and complexity to their images. For instance, brush techniques using pressure or brush “English” to produce a particular esthetic effect, and those in which the bristles are laid against the art surface so that the trajectories of the brush ends play only a small role in producing the intended image, exceed the capacity of this conventional approach to faithfully reproduce the esthetic vision of the artist.

Accordingly, there is a need to overcome the drawbacks and deficiencies in the conventional art by providing a system and method enabling the production of detailed, esthetically nuanced, art images electronically.

### SUMMARY OF THE INVENTION

There are provided systems and methods for producing art electronically, substantially as shown in and/or described in connection with at least one of the figures, as set forth more completely in the claims.

### BRIEF DESCRIPTION OF THE DRAWINGS

The features and advantages of the present invention will become more readily apparent to those ordinarily skilled in the art after reviewing the following detailed description and accompanying drawings, wherein:

FIG. 1 shows a diagram of an electronic art system, according to one embodiment of the present invention;

FIG. 2 is a flowchart presenting a method for producing art electronically, according to one embodiment of the present invention;

FIG. 3 shows a diagram of an electronic art system, according to a second embodiment of the present invention;

FIG. 4 shows a diagram of an electronic art system, according to a third embodiment of the present invention;

FIG. 5 shows a diagram of an electronic art system, according to a fourth embodiment of the present invention; and

FIG. 6 shows a diagram of an electronic art system, according to a fifth embodiment of the present invention.

### DETAILED DESCRIPTION OF THE INVENTION

The present application is directed to an electronic art system and a related method. The following description contains specific information pertaining to the implementation of the present invention. One skilled in the art will recognize that the present invention may be implemented in a manner different from that specifically discussed in the present application. Moreover, some of the specific details of the invention are not discussed in order not to obscure the invention. The specific details not described in the present application are within the knowledge of a person of ordinary skill in the art. The drawings in the present application and their accompanying detailed description are directed to merely exemplary embodiments of the invention. To maintain brevity, other embodiments of the invention, which use the principles of the present invention, are not specifically described in the present application and are not specifically illustrated by the present drawings. It should be borne in mind that, unless noted otherwise, like or corresponding elements among the figures may be indicated by like or corresponding reference numerals.

As a result of the several significant limitations associated with conventional approaches to enabling the production of art images electronically, described above, artists and animators attempting to utilize those approaches may be substantially frustrated in manifesting the full complement of their artistic skills. Consequently, much of conventionally produced electronic artwork may seem primitive, or at least to lack sophistication, when compared with artwork produced using traditional non-electronic tools and media. In particular, electronic art produced conventionally may be seen to lack the fine grained textured effects produced by skillful application and control of the bristles of a traditional art brush, as well as the nuance and complexity imparted by advanced brush techniques using pressure, variations in the angle with which the brush is applied to an art surface, and brush “English” applied during a brushstroke.

The present inventors realize that by rendering the bristles of an otherwise traditional art brush electrically conductive, and detecting the electrical pattern resulting from interaction between those conductive bristles and an electrically sensitive art surface during a brushstroke, an electronic image of the brushstroke may be produced. Moreover, by making the bristles electrically conductive over a substantial portion of their respective possible contact areas with the art surface, that resulting image can faithfully reproduce subtle characteristics of the brushstroke, such as pressure, angle, and “English”, heretofore beyond the ability of electronic art systems and methods to capture.

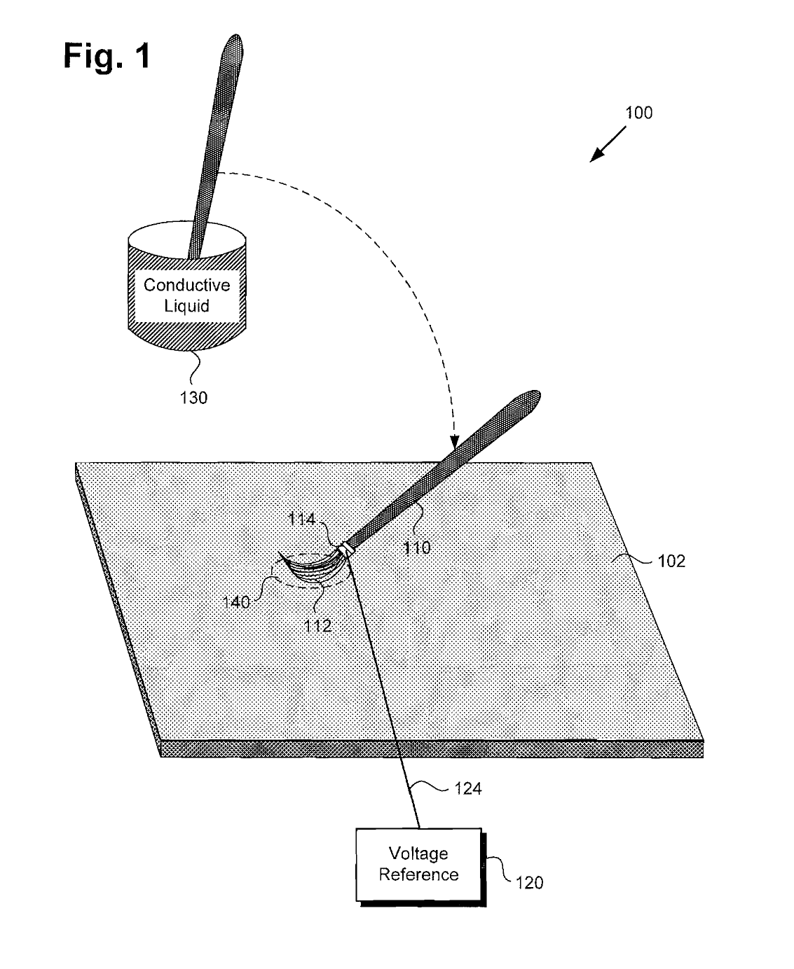

FIG. 1 shows a diagram of an electronic art system, according to one embodiment of the present invention, capable of overcoming the drawbacks and deficiencies of conventional approaches to producing art electronically. In the embodiment of FIG. 1, electronic art system 100 comprises electrically sensitive art surface 102, art brush 110 having bristles 112, voltage reference 120, and at least lightly conductive liquid 130.

Electrically sensitive art surface 102 may comprise a touch sensitive surface, such as a projected capacitance touch sensitive surface, for example. Alternatively, in other embodiments, electrically sensitive art surface 102 may comprise electronic paper (e-paper), as known in the art, or a surface comprising an electro-luminescent film, for example. It is noted that although the specific embodiments described in the present application may appear to characterize electrically sensitive art surface 102 as a portable art surface, such as the electronic analogue of a canvas or slate, for example, that need not be the case. Implementation of the inventive principles disclosed herein is readily scalable to both smaller and larger electrically sensitive art surfaces. For example, as may be apparent to one of skill in the art, an electrically sensitive art surface implementing touch detection technology or comprising electro-luminescent materials may be appropriately adapted and scaled to serve as an electrically sensitive art wall surface or floor surface corresponding to a wide range of possible surface areas.

The present inventors contemplate that art brush 110 may comprise a traditional art brush available from an art supply store and having a conductive or non-conductive handle, as well as bristles 112 in contact with conductive clamp or ferule 114 facilitating coupling of bristles 112 to voltage reference 120. However, in some embodiments, art brush 110 may be a specially constructed art tool designed to enable coupling of bristles 112 to voltage reference 120 so as to optimize freedom of motion for an artist or animator using art brush 110 to execute a brushstroke.

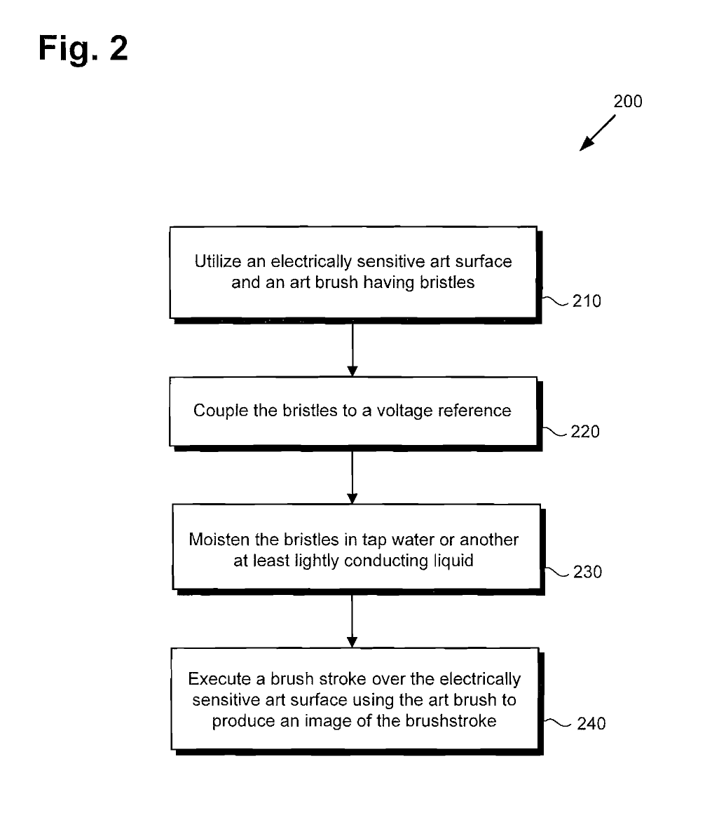

The operation of electronic art system 100 will be further described in combination with flowchart 200, in FIG. 2. Flowchart 200 describes the steps, according to one embodiment of the present invention, of a method for producing art electronically. Certain details and features have been left out of flowchart 200 that are apparent to a person of ordinary skill in the art. For example, a step may comprise one or more substeps or may involve specialized equipment or materials, as known in the art. While steps 210 through 240 indicated in flowchart 200 are sufficient to describe one embodiment of the present method, other embodiments may utilize steps different from those shown in flowchart 200, or may include more, or fewer steps.

Referring to step 210 in FIG. 2, step 210 of flowchart 200 comprises utilizing an electrically sensitive art surface and an art brush having bristles. Step 210 may be performed using electronic art system 100, in FIG. 1. By way of providing a specific example electronic art system environment for performance of the present method, let us assume that electrically sensitive art surface 102 is a projected capacitance touch sensitive surface and that art brush 110 is a traditional art brush having natural or synthetic bristles 112 of the type typically used to apply ink or paint to a canvas surface. When properly adapted for use together, as described below, art brush 110 and electrically sensitive art surface 102 may be utilized in combination to produce detailed, nuanced, art images electronically.

Moving to step 220 of FIG. 2 and continuing to refer to electronic art system 100, in FIG. 1, step 220 of flowchart 200 comprises coupling bristles 112 to voltage reference 120. According to the embodiment shown in FIG. 1, art brush 110 includes electrically conductive clamp or ferule 114, such as a metal clamp or ferule, for example, in contact with bristles 112. Thus, whether or not art brush 110 includes a conductive handle, bristles 112 may be coupled to voltage reference 120 through their contact with electrically conductive clamp or ferule 114 and connector (e.g., wire) 124. In general, voltage reference 120 may comprise a direct-current (DC) voltage source, alternating-current (AC) voltage source, or a ground terminal, for example.

For the specific example electronic art system environment described above, that is to say wherein electrically sensitive art surface 102 comprises a projected capacitance touch sensitive surface, it is contemplated that voltage reference 120 may comprise a connection to ground. For instance, where art brush 110 is utilized by a human artist or animator, voltage reference 120 may take the form of a simple ground strap worn on the wrist of the artist or animator. It is noted that although the present discussion has characterized art brush 110 as being utilized by a human artist or animator, other arrangements are contemplated as well. For example, in one embodiment, electronic art system 100 may be implemented as an automated system wherein art brush 110 could be utilized by a robot, or other mechanism for automating execution of a brushstroke using art brush 110. In those latter embodiments, step 220 may be performed by coupling bristles 112 to a ground terminal of electronic art system 100, for example, using connector 124.

Flowchart 200 continues with step 230, which comprises moistening bristles 112 in an at least lightly conductive liquid 130. At least lightly conductive liquid 130 can comprise any solution including free charge carriers. For example, at least lightly conductive liquid 130 may take the form of a slightly ionized aqueous solution, such as tap water, for example. Once again, step 230 can be performed using electronic art system 100.

Referring now to step 240 in FIG. 2, step 240 of flowchart 200 comprises executing a brush stroke over electrically sensitive art surface 102 using art brush 110 to produce image 140 of the brushstroke. Step 240 may be performed by electronic art system 100 under the control of a human or mechanical operator, for example. According to the specific embodiment in which electrically sensitive art surface 102 comprises a projected capacitance touch sensitive surface and art brush 110 is a traditional art tool having nominally non-conductive bristles 112, coupling bristles 112 to voltage reference 120 (e.g., a ground terminal) and moistening bristles 112 with at least lightly conductive liquid 130 enables an interaction between electrically characterized (e.g., grounded) bristles 112 and the electric field generated by projected capacitance touch sensitive art surface 102, resulting in formation of an electrical pattern. Moreover, because each of electrically characterized bristles 112 in sufficient proximity to electrically sensitive art surface 102 contributes to the electrical pattern producing image 140, image 140 can be seen to be a substantially more faithful representation of the executed brushstroke than can be produced using conventional electronic art systems utilizing a stylus or a light emitting electronic brush.

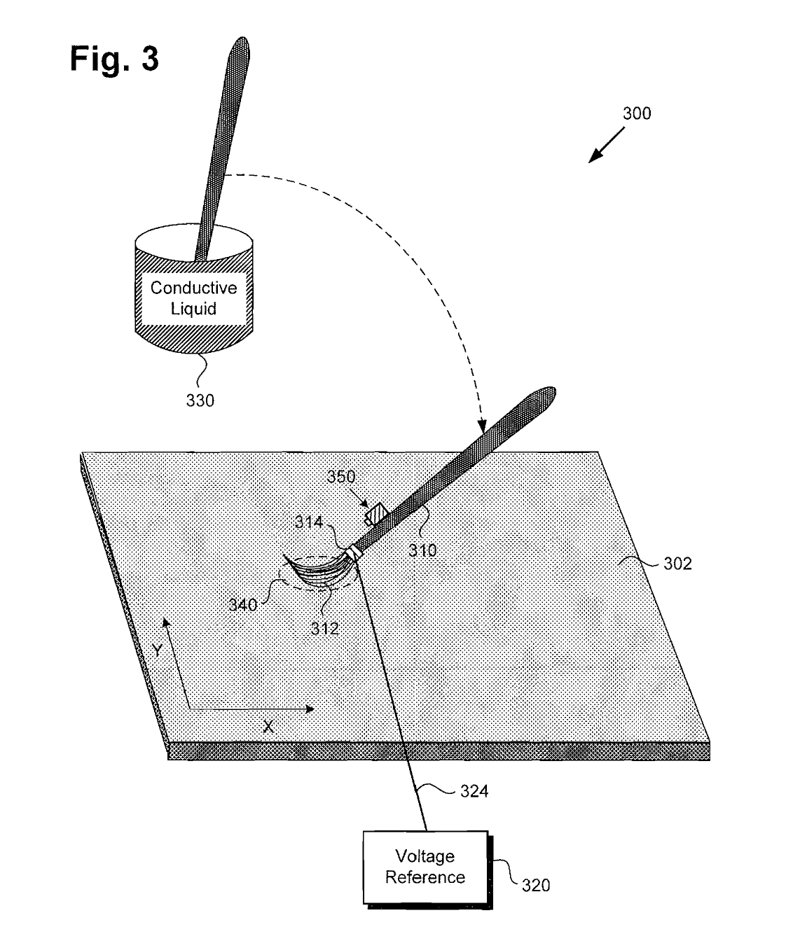

The resolution achievable using electronic art system 100 may be sufficient to produce images of significantly greater detail, complexity, and nuance than may be achieved using conventional approaches to producing art electronically. In fact, depending upon the detection granularity provided by electrically sensitive art surface 102, image 140 may be a high-resolution image of the brushstroke executed using art brush 110. However, in other embodiments of the present invention, additional features may be introduced and additional steps may be performed to further enhance the resolution and/or quality of image 140. FIGS. 3, 4, 5, and 6 present additional exemplary embodiments of the present invention employing a variety of supplemental features and techniques.

Referring next to FIG. 3, FIG. 3 shows a diagram of electronic art system 300, according to a second embodiment of the present invention. Electronic art system 300 includes electrically sensitive art surface 302, art brush 310 having bristles 312 coupled to voltage reference 320 by connector 324 and electrically conductive clamp or ferule 314, and at least lightly conductive liquid 330, corresponding respectively to electrically sensitive art surface 102, art brush 110 having bristles 112 coupled to voltage reference 120 by connector 124 and electrically conductive clamp or ferule 114, and at least lightly conductive liquid 130, in FIG. 1. In addition, electronic art system 300, in FIG. 3, further comprises camera 350, having no analogue in the system of FIG. 1.

Camera 350 can be configured to capture an optical image of the brushstroke producing image 340. Camera 350 may comprise a standard-definition or high-definition (HD) camera, for example, and in the latter instance may be used to produce a high resolution optical image of the brushstroke executed using art brush 310. As shown in FIG. 3, in one embodiment, camera 350 comprises a miniature camera affixed to the handle of art brush 310. In that embodiment, camera 350 may be expected to capture an optical image of a region localized to image 340 resulting from the interaction between bristles 312 and electrically sensitive art surface 302. Additional information characterizing image 340, such as its location on an x-y coordinate plane corresponding to electrically sensitive art surface 302 can be gleaned from the electrical pattern formed by the interaction between bristles 312 and electrically sensitive art surface 302.

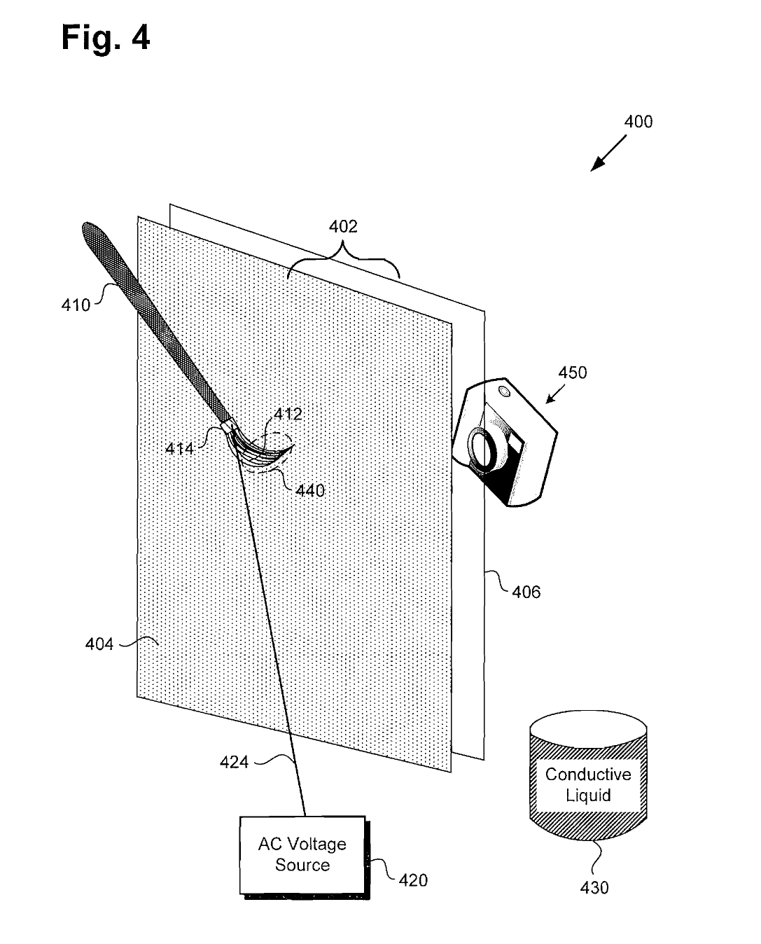

Continuing to FIG. 4, FIG. 4 shows a diagram of electronic art system 400, according to a third embodiment of the present invention. Electronic art system 400 includes electrically sensitive art surface 402, art brush 410 having bristles 412 coupled to AC voltage source 420 by connector 424 and electrically conductive clamp or ferule 414, at least lightly conductive liquid 430, and still, or moving-image camera 450, corresponding respectively to electrically sensitive art surface 302, art brush 310 having bristles 312 coupled to voltage reference 320 by connector 324 and electrically conductive clamp or ferule 314, at least lightly conductive liquid 330, and camera 350, in FIG. 3.

In one embodiment, electrically sensitive art surface 402 can be implemented using an electro-luminescent material. For example, as shown in FIG. 4, in that embodiment, electrically sensitive art surface 402 comprises electro-luminescent film 404 over transparent electrode 406, while the charge carried by moistened bristles 412 is controlled by AC voltage source 420. Electro-luminescent film 404 may be formed through deposition or adsorption of an electro-luminescent paint, for example, onto a plastic or other transparent support surface. Transparent electrode 406 may be implemented by coating a transparent plastic sheet with indium tin oxide, for example, rendering it conductive. Execution of a brushstroke applying AC driven bristles 412 to electro-luminescent art surface 402 can be expected to produce a transient luminescent pattern forming image 440. According to the embodiment shown in FIG. 4, camera 450 is placed behind electrically sensitive art surface 402 to capture an optical image of the brushstroke through transparent electrode 406. In other words, in electronic art system 400, electrically sensitive (e.g., electro-luminescent) art surface 402 is situated between camera 450 and art brush 410. Camera 450 may store the cumulative brushstroke images, over time, to compile a substantially complete artistic rendering, and make the completed artistic rendering available in digital form for storage, electronic modification, transmission, or display, for example.

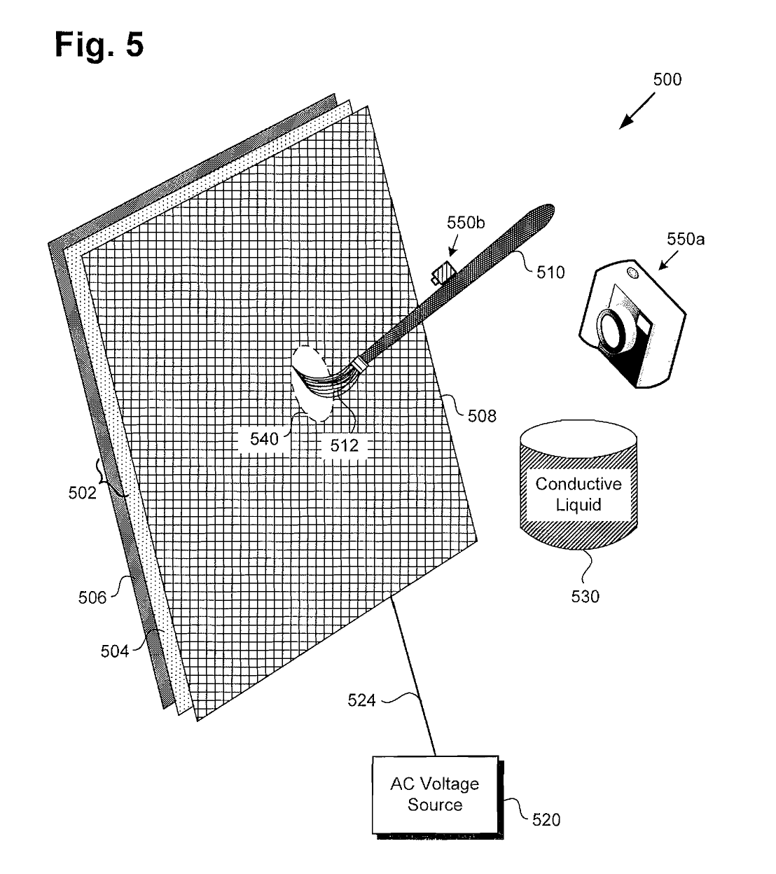

Referring to FIG. 5, FIG. 5 shows a diagram of electronic art system 500, according to a fourth embodiment of the present invention. Electronic art system 500 includes electrically sensitive art surface 502 comprising electro-luminescent film 504 and opaque electrode 506, art brush 510 having bristles 512, AC voltage source 520, connector 524, at least lightly conductive liquid 530, and cameras 550a and 550b, corresponding respectively to electrically sensitive art surface 402 comprising electro-luminescent film 404 and transparent electrode 406, art brush 410 having bristles 412, AC voltage source 420, connector 424, at least lightly conductive liquid 430, and camera 450, in FIG. 4. Electronic art system 500 further comprises conductive micro-screen 508, which is omitted from electronic art system 400 embodied in FIG. 4. Moreover, and in contrast to the arrangement shown in FIG. 4, in the implementation shown by FIG. 5, connector 524 couples conductive micro-screen 508 to AC voltage source 520, thereby enabling use of a conventional art brush as art brush 510.

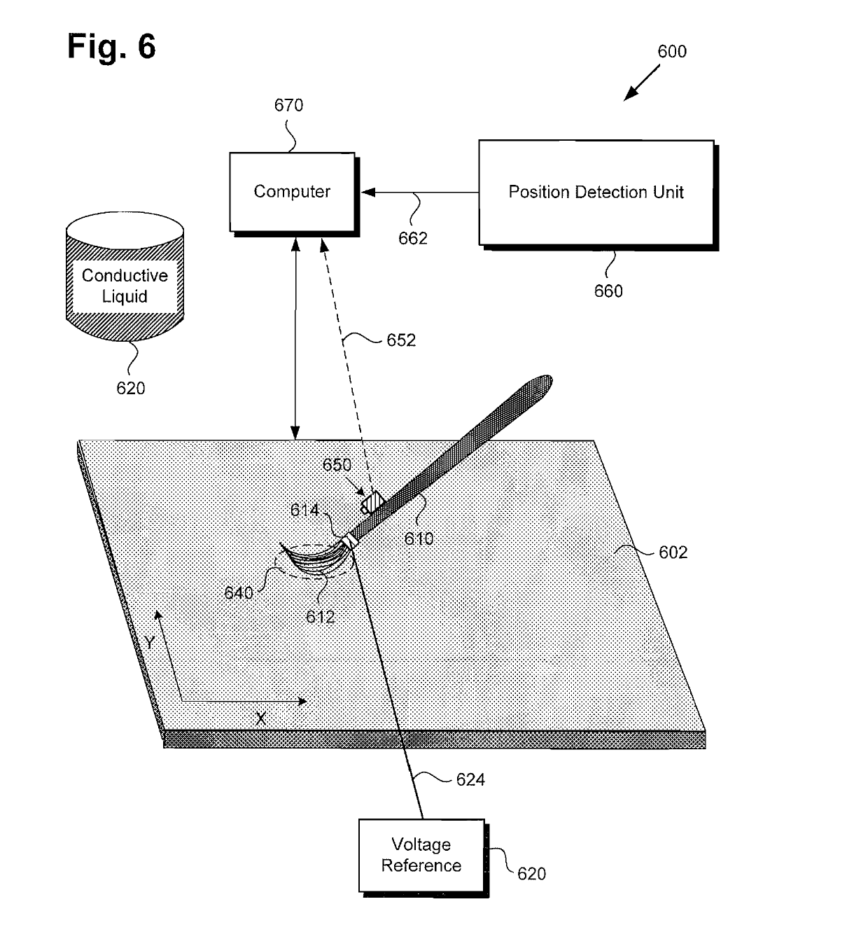

As was the case in the embodiment of electronic art system 400, electrically sensitive art surface 502, in FIG. 5, is implemented as an electro-luminescent art surface. However, and in further contrast to the embodiment shown in FIG. 4, electrode 506, in FIG. 5, may be opaque, rather than transparent, and camera 550a can be placed in front of electrically sensitive art surface 502 to capture images from the front side. Alternatively, or in addition, camera 550b can be used and placed in front of electrically sensitive art surface 502, for example by being a miniature camera affixed to art brush 510, in which instance, the image captured by camera 550b may be integrated into the overall artistic rendering through x-y location as described later in conjunction with FIG. 6. It is further noted that conductive micro-screen 508 is disposed over, but slightly spaced away from, electrically sensitive art surface 502, and is configured to provide a residual image of the brushstroke producing image 540 as follows.

As explained above with reference to FIG. 4, an interaction between moistened bristles 512 and electrically sensitive art surface 502 including electro-luminescent film 504 produces a transient luminescent pattern forming image 540. According to the embodiment of electronic art system 500, however, execution of a brushstroke applying bristles 512 to conductive micro-screen 508 can be expected to transfer and trap some of electrically conductive liquid 530 from moistened bristles 512 into the mesh of conductive micro-screen 508 at image 540. The presence of trapped electrically conductive liquid 530 in the mesh of conductive micro-screen 508 will bridge the small gap between conductive micro-screen 508 and electroluminescent film 504 and sustain a prolonged luminescent pattern providing a residual image corresponding to image 540. Moreover, that residual image can be expected to persist for some interval of time, such as several seconds or several minutes, for example, after execution of the brushstroke producing image 540. If desired, at least lightly conductive liquid 530 may dry in a conductive state making a permanent image.

Moving to FIG. 6, FIG. 6 shows a diagram of electronic art system 600, according to a fifth embodiment of the present invention. Electronic art system 600 includes electrically sensitive art surface 602, art brush 610 having bristles 612 coupled to voltage reference 620 by connector 624 and electrically conductive claw or ferule 614, and at least lightly conductive liquid 630, corresponding respectively to electrically sensitive art surface 102, art brush 110 having bristles 112 coupled to voltage reference 120 by connector 124 and electrically conductive clamp or ferule 114, and at least lightly conductive liquid 130, in FIG. 1. In addition, electronic art system 600, in FIG. 6, further comprises camera 650, position detection unit 660, and computer 670.

As is true for camera 550b with respect to image 540, in FIG. 5, camera 650, in FIG. 6, can be configured to capture an optical image of the brushstroke producing image 640. Camera 550b/650 may comprise an HD camera, for example, and may be used to produce a high-resolution optical image of the brushstroke executed using art brush 510/610. As further shown in FIGS. 5 and 6, camera 550b/650 can comprise a miniature camera affixed to the handle of art brush 510/610, in which case it may be expected to capture an optical image of a region localized to image 540/640. According to the embodiment of FIG. 6, additional information characterizing image 640, such as its location on an x-y coordinate plane corresponding to electrically sensitive art surface 602, can be provided by position detection unit 660. A corresponding position detection unit may be utilized as part of electronic art system 500, in FIG. 5 (position detection unit not shown as such in FIG. 5).

Referring to FIG. 6, position detection unit 660 may comprise another camera, for example, supplemental to camera 650 (e.g. a camera corresponding to camera 550a, in FIG. 5). In that embodiment, position detection unit camera 660 may be configured and positioned to capture another optical image including substantially all of electrically sensitive art surface 602. Alternatively, position detection unit 660 may comprise an x-y scanner, or any other suitable detector for identifying the location of the brushstroke executed by art brush 610, on electrically sensitive art surface 602.

As shown by FIG. 6, in one embodiment, computer 670 may be interactively connected to electrically sensitive art surface 602. In addition, computer 670 may be configured to receive data from camera 650 and position detection unit 660 over respective communication links 652 and 662, which may be wired or wireless communication links. Computer 670 can be configured to process the data received from camera 650 (e.g., the optical image of the brushstroke) and the location data received from position detection unit 660 to produce image 640. Moreover, where camera 650 provides data corresponding to a localized optical image of the brushstroke and position detection unit 660 comprises another camera providing an optical image of substantially all of electrically sensitive art surface 602, computer 670 can be configured to process the respective optical images received respectively from camera 650 and position detection unit camera 660 to produce image 640.

As may be apparent from FIG. 6, the embodiment represented by electronic art system 600 allows for a variety of alternative arrangements. For instance, in embodiments in which the x-y location of the brushstroke is provided by electrically sensitive art surface 602, as in the embodiment of FIG. 3, for example, position detection unit 660, in FIG. 6, may be omitted entirely, and computer 670 can be configured to process image 640 from the data received from camera 650 and from data provided by electrically sensitive art surface 602. In other embodiments, however, electrically sensitive art surface may be utilized primarily as an electronic display surface, so that computer 670 may be configured not to rely on data from electrically sensitive art surface to produce image 640, but rather to process data from position detection unit 660 and camera 650 to produce that image. In those latter embodiments, computer 670 can be further configured to render image 640 on electrically sensitive art surface 602, which may comprise a display panel such as a back-lit liquid crystal display (LCD), or total internal reflection (TIR) based display system, for example.

Thus, embodiments of the electronic art systems and methods disclosed in the present application are capable of producing highly detailed, complex, and nuanced art images electronically. Moreover, embodiments of the present invention enable generation of electronic images that faithfully recreate the visual effects produced by a wide range of important brushstroke techniques favored by artists and animators, and heretofore beyond the ability of conventional electronic art systems to effectively simulate. In addition, the embodiments disclosed herein are highly scalable, thereby advantageously facilitating implementation of the present inventive principles using electrically sensitive art surfaces of varying sizes and in a variety of visual environments.

From the above description of the invention it is manifest that various techniques can be used for implementing the concepts of the present invention without departing from its scope. Moreover, while the invention has been described with specific reference to certain embodiments, a person of ordinary skill in the art would recognize that changes can be made in form and detail without departing from the spirit and the scope of the invention. It should also be understood that the invention is not limited to the particular embodiments described herein, but is capable of many rearrangements, modifications, and substitutions without departing from the scope of the invention.

What is claimed is:

1. An electronic art system comprising;
an electrically sensitive art surface;
an art brush having bristles;
a voltage reference coupled to the bristles of the art brush; and
an at least lightly conductive liquid for moistening the bristles;
an electrical pattern formed by an interaction between a plurality of the moistened bristles of the art brush executing a brushstroke and the electrically sensitive art surface resulting in production of an image of the brushstroke.

2. The electronic art system of claim 1, wherein the image is a high-resolution image of the brushstroke.

3. The electronic art system of claim 1, wherein the electrically sensitive art surface comprises a projected capacitance touch sensitive surface.

4. The electronic art system of claim 1, wherein the electrically sensitive art surface comprises electronic paper (e-paper).

5. The electronic art system of claim 1, wherein the electrically sensitive art surface comprises an electro-luminescent film.

6. The electronic art system of claim 1, wherein the voltage reference comprises a ground terminal.

7. The electronic art system of claim 1, wherein the voltage reference comprises a direct-current (DC) voltage source.

8. The art system of claim 1, wherein the voltage reference comprises an alternating-current (AC) voltage source.

9. The electronic art system of claim 1, wherein the at least lightly conductive liquid comprises ionized water.

10. The electronic art system of claim 1, further comprising a camera configured to capture an optical image of the brushstroke.

11. The electronic art system of claim 10, wherein the camera comprises a miniature camera affixed to the art brush.

12. The electronic art system of claim 10, wherein the electrically sensitive art surface is situated between the camera and the art brush.

13. The electronic art system of claim 1, further comprising a conductive micro-screen disposed over the electrically sensitive art surface, the conductive micro-screen configured to provide a residual image of the brushstroke.

14. The electronic art system of claim 1, further comprising;
a camera configured to capture an optical image of the brushstroke;
to a position detection unit for identifying a location of the brushstroke on the electrically sensitive art surface; and
a computer configured to process at least the optical image and the location to produce the image of the brushstroke.

15. The electronic art system of claim 14, wherein the position detection unit comprises another camera positioned to capture another optical image including substantially all of the electrically sensitive art surface, and wherein the computer is configured to process at least the optical image and the another optical image to produce the image of the brushstroke.

16. A method for producing art electronically, the method comprising:
utilizing an electrically sensitive art surface and an art brush having bristles;
coupling the bristles to a voltage reference;
moistening the bristles using an at least lightly conductive liquid; and
executing a brushstroke over the electrically sensitive art surface using the art brush;
an electrical pattern formed by an interaction between a plurality of the moistened bristles and the electrically sensitive art surface resulting in production of an image of the brushstroke.

17. The method of claim 16, wherein the image is a high-resolution image of Jo the brushstroke.

18. The method of claim 16, further comprising capturing an optical image of the brushstroke.

19. The method of claim 16, further comprising providing a residual image of the brushstroke.

20. The method of claim 16, further comprising:
capturing an optical image of the brushstroke;
identifying a location of the brushstroke on the electrically sensitive art surface; and
computer processing at least the optical image and the location to produce the image of the brushstroke.
